(19) United States
(12) Patent Application Publication
(10) Pub. No.: US 2006/0171696 A1
(43) Pub. Date: Aug. 3, 2006

(54) Imaging apparatus

(76) Inventors: Shigeki Murata, Nara (JP); Michihiro Yamagata, Osaka (JP); Kazutake Boku, Hirakata (JP); Yasuhiro Tanaka, Nishinomiya (JP); Kenichi Hayashi, Ikoma (JP); Yoshimasa Fushimi, Neyagawa (JP); Hiroaki Okayama, Osaka (JP); Takayuki Hayashi, Yawata (JP)

Correspondence Address: PANASONIC PATENT CENTER;c/o MCDERMOTT WILL & EMERY LLP, 600 13TH STREET, NW, WASHINGTON, DC, 20005-3096, US

(21) Appl. No.: 11/344,198

(22) Filed: Feb. 1, 2006

(30) Foreign Application Priority Data
Feb. 2, 2005 (JP) 2005-026128

(51) Int. Cl. G03B 17/00

(52) U.S. Cl. 396/72

(57) ABSTRACT

An imaging apparatus includes an imaging optical system for forming an optical image of an object, the imaging optical system including a focal length adjusting section adjustable a focal length based on an input signal and a plurality of image forming lenses for receiving a light that has transmitted through said focal length adjusting section to form the optical image of the object, and an image sensor for generating an electrical image signal obtained by converting the optical image, wherein a unit is composed of each of the image forming lens and an image taking area on the image sensor having a plurality of light receiving sections for receiving the optical image, and a plurality of units being two-dimensionally arranged, so that it is possible to provide the imaging apparatus with high convenience, which is reduced in thickness, and whose focal length adjustable.

### BACKGROUND OF THE INVENTION

1. Field of the Invention

The present invention relates to an imaging apparatus provided with a compound-eye optical system, and relates specifically to an imaging apparatus whose focal length can be adjusted.

2. Description of the Background Art

In recent years, integration density of an imaging apparatus, such as a CCD (Charge Coupled Device) and a CMOS (Complementary Metal-Oxide Semiconductor), and signal processing being used for it has been increased, and the CCD and the CMOS have been able to be provided at low cost, so that a digital still camera and a digital video camera (hereinafter, referred merely to as a digital camera) capable of converting an optical image of a object into an electrical image signal to output it therefrom have rapidly come into widespread use.

Moreover, with downsizing of electronic apparatuses or portable devices in recent years, a digital camera mountable in these apparatuses has been required. An imaging apparatus and an optical system that have been reduced in size and in thickness have been proposed for this requirement.

As one of the proposals, in Japanese Unexamined Patent Publication (Kokai) No. 2001-61109 (hereinafter, referred to as Patent Document 1), an imaging apparatus provided with an optical system imitating a compound-eye structure that an insect or the like has is proposed. As shown in FIG. 6, an imaging apparatus provided with a compound-eye optical system is constituted mainly by a lens array 101 composed of a plurality of image forming lenses, an image sensor 103 on a plane arranged opposing to the lens array 101, and a partition 102 for serving as a screen. Respective image forming lenses form optical images of a object in predetermined areas on the image sensor 103, respectively. As a result, reduced images with low resolution, the number of which is equal to that of the image forming lenses composing the lens array 101 are formed on an image sensor 103. A single object image is reconfigured by performing predetermined reconstruction processing based on the plurality of reduced images. By employing such a compound-eye optical system, reduction in size in an optical axis direction may be achieved, so that it becomes possible to reduce an entire imaging apparatus in size and in thickness.

Meanwhile, in Japanese Unexamined Patent Publication (Kokai) No. 2000-347005 (hereinafter, referred to as Patent Document 2), a liquid lens arranged in an optical path is disclosed. The liquid lens is provided with an electrically insulating liquid that serves as a lens on an insulating layer provided on an inner surface of a cell, which is filled with a conductive liquid. Patent Document 2 has proposed a technique, in which by controlling a voltage applied to the cell to thereby vary boundary tension of the conductive liquid, a shape of the electrically insulating liquid has been changed, resulting in a change in a focal point of the lens.

In addition, Japanese Unexamined Patent Publication (Kokai) No. H 11-109304 (hereinafter, referred to as Patent Document 3) has proposed a technique, in which by filling a liquid crystal in an element arranged in an optical path to thereby control a voltage applied to the liquid crystal, an image forming position of a transmitted light beam has been moved in an optical axis direction.

The area of the object taken by the imaging apparatus provided with the compound-eye optical system described in Patent Document 1 depends on an angle of field of a lens array composed of the plurality of image forming lenses. On the contrary, there has been proposed a configuration, in which by providing a deflection member on a object side of the lens array, a object light has been entered into the image forming lens positioned in a vicinity of an edge of the lens array, so that a visual field to the object could be secured. However, since the focal length has been fixed, an imaging apparatus that can adjust the focal length like a zoom lens has not been proposed yet.

As for the liquid lens described in Patent Document 2, reducing a driving voltage for changing a focal length is discussed, however, reducing the entire imaging apparatus in size by combining other optical systems has not been proposed.

Moreover, since the liquid crystal lens described in Patent Document 3 is a lens used for an optical coupling device of an optical communication field, it is for use in a laser optical system, and so that using it in a wide wavelength band like a digital camera is not discussed. Furthermore, since the liquid crystal lens described in Patent Document 3 is a lens used for an optical coupling device, using it in an optical system that requires an image formation of an off-axis light as the digital camera is not discussed.

It is therefore an object of the present invention to provide an imaging apparatus with high convenience, which is provided with a compound-eye optical system capable of being reduced in size and in thickness, and can adjust the focal length.

### SUMMARY OF THE INVENTION

The object of the present invention can be achieved by an imaging apparatus provided with a following configuration.

An imaging apparatus includes an imaging optical system for forming an optical image of an object, the imaging optical system including a focal length adjusting section adjustable a focal length based on an input signal and a plurality of image forming lenses for receiving a light that has transmitted through said focal length adjusting section to form the optical image of the object; and an image sensor for generating an electrical image signal obtained by converting the optical image, wherein a unit is composed of each of the image forming lens and an image taking area on the image sensor having a plurality of light receiving sections for receiving the optical image, and a plurality of units being two-dimensionally arranged.

According to this configuration, since the imaging optical system is reduced in size in an optical axis direction, a small-sized imaging apparatus having a zoom function can be provided.

As described above, the present invention can provide an imaging apparatus with high convenience, which is provided with a compound-eye optical system capable of being reduced in size and in thickness, and can adjust a focal length.

These and other objects, features, aspects, and advantages of the present invention will become more apparent from the following detailed description of the present invention when taken in conjunction with the accompanying drawings.

### BRIEF DESCRIPTION OF THE DRAWINGS

FIG. 1 is a schematic diagram showing a configuration of an imaging apparatus according to a first embodiment;

FIG. 2 is a schematic diagram showing a configuration of a compound-eye optical system according to the first embodiment;

FIG. 3A is an illustration of a relationship between a liquid lens and an image taking area according to the first embodiment;

FIG. 3B is an illustration of a relationship between the liquid lens and the image taking area according to the first embodiment;

FIG. 4 is a schematic diagram showing a configuration of an imaging apparatus according to a second embodiment;

FIG. 5A is a chart showing a relationship between applied voltages to a liquid crystal lens of the imaging apparatus and a refractive index distribution in a direction perpendicular to an optical axis direction according to the second embodiment;

FIG. 5B is a chart showing a relationship between the applied voltages to the liquid crystal lens of the imaging apparatus and the refractive index distribution in the direction perpendicular to the optical axis direction according to the second embodiment; and

FIG. 6 is a schematic diagram showing a configuration of a compound-eye optical system.

### DETAILED DESCRIPTION OF THE PREFERRED EMBODIMENTS

### First Embodiment

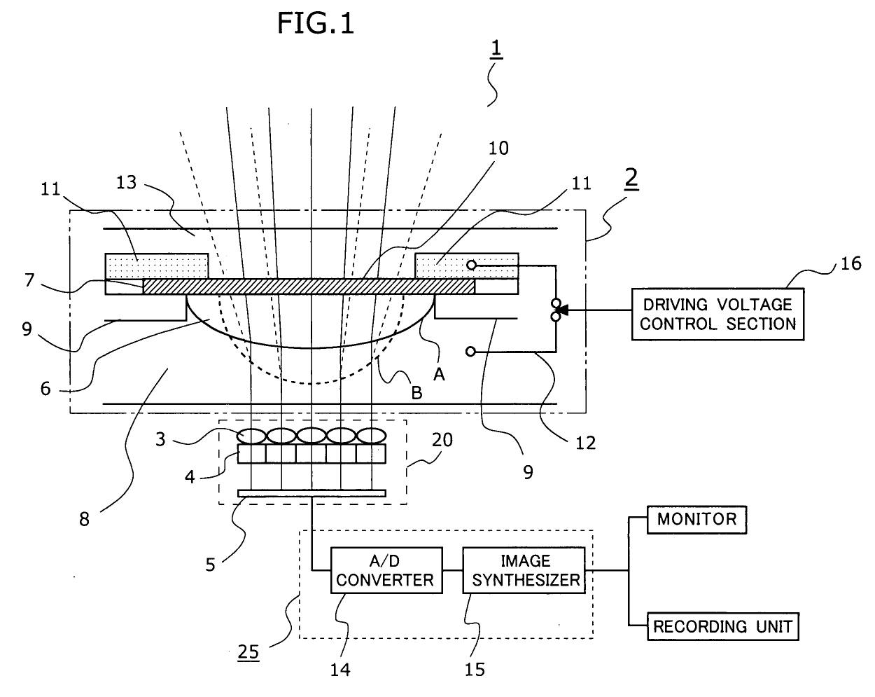

FIG. 1 is a schematic diagram showing a configuration of an imaging apparatus according to a first embodiment of the present invention. In FIG. 1, an imaging apparatus includes a liquid lens 2, a compound-eye optical system 20, a signal processing section 25, and a driving voltage control section 16.

The liquid lens 2 corresponds to a focal length changing section, which can adjust a focal length. A driving voltage inputted to the liquid lens 2 is controlled by the driving voltage control section 16. In addition, the liquid lens 2 is provided with an electrically insulating liquid 6, a conductive liquid 8, a thin film insulating layer 7, a surface processing section 9, electrodes 11 and 12, and a base material 13. The electrically insulating liquid 6 and the conductive liquid 8 have different refractive indexes, do not mutually mixed, and have almost the same density.

The liquid lens 2 is arranged in an optical path. The inside of a cell of the liquid lens 2 is filled with the conductive liquid 8. The conductive liquid 8, the electrically insulating liquid 6, and the base material 13 composed of glass are transparent, respectively, and transmit a light. As indicating by reference numeral A in FIG. 1, the electrically insulating liquid 6 keeping a semi-spherical surface shape has a function as a lens which can focus a light beam. The electrically insulating liquid 6 is arranged on a surface of the thin film insulating layer 7 on a side of the image sensor 5. In addition, a central axis of the electrically insulating liquid 6 is perpendicular to the thin film insulating layer 7, and is equal to an optical axis of the liquid lens 2. The electrode 11 is placed on a surface of the thin film insulating layer 7 on a object side via the thin film insulating layer 7 so as to be overlapped with a part of an area of the electrically insulating liquid 6. Meanwhile, the other electrode 12 is placed so as to be electrically connected to the conductive liquid 8. The surface of the thin film insulating layer 7 has a hydrophobic property to the conductive liquid 8, and the surface processing section 9 having a hydrophilic property to the conductive liquid 8 is formed on a part of the surface thereof. As a result, the conductive liquid 8 is present around the electrically insulating liquid 6 and the surface processing section 9. The object light transmits through the base material 13, the electrically insulating liquid 6, and the conductive liquid 8, respectively, and after being emitted from the base material 13 on an image sensor side, enters into the compound-eye optical system 20.

When a voltage is applied between the electrode 11 and the electrode 12 by the driving voltage control section 16, the hydrophobic property of the thin film insulating layer 7 is reduced, and a boundary tension of the conductive liquid 8 is varied. In other words, a contact region between the conductive liquid 8 and the thin film insulating layer 7 is increased. Accordingly, as indicating by reference numeral B in FIG. 1, a radius of curvature of the electrically insulating liquid 6 with the semi-spherical surface shape is varied and a focal length thereof is thereby reduced without varying the central axis. As described above, the focal length of the electrically insulating liquid 6 is changed in accordance with the applied voltage. Hence, the focal length of the liquid lens 2 can be changed by controlling the voltage to be applied thereto.

The compound-eye optical system 20 is constituted mainly by a lens array 3 composed of a plurality of image forming lenses, a partition 4, and an image sensor 5. The lens array 3 is composed of the image forming lenses which are arranged in parallel, and is arranged opposing to the image sensor 5. As compared with a single optical system that forms an optical image using one image forming lens, since respective image forming lenses are minute, a distance between the image forming lens and the image sensor 5 is reduced. In this embodiment, the lens array 3 is composed of a total of 25 image forming lenses, namely five lenses in an X direction and five lenses in a Y direction, respectively, in a single plane.

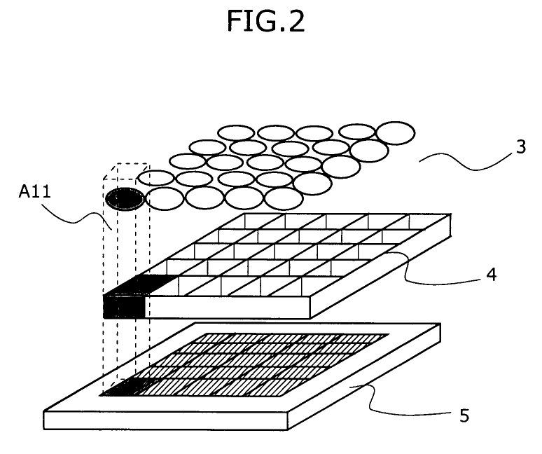

The image sensor 5 is a CCD (Charge Coupled Device), and converts the optical image formed by the image forming lens into an electrical signal. A plurality of light receiving sections for introducing an entered light beam are formed on the image sensor 5. Moreover, image taking areas the number of which is equal to that of the image forming lenses are formed on the image sensor 5, and a plurality of light receiving sections are included in one image taking area. Here, as shown in FIG. 2, each of image forming optical systems is used as a unit, and one unit is composed of one image forming lens and the one image taking area. As a result, according to the present embodiment, 25 units are formed and a plurality of these units are two-dimensionally arranged. Hence, a light beam entering into one image forming lens forms an image in one imaging area, and is converted into an electrical analog signal. It should be noted that a CMOS (Complementary Metal-Oxide Semiconductor) might be used as the image sensor 5.

The partition 4 serves as a screen between the lens array 3 and the image sensor 5. As a result of this, it is possible to prevent that an image formed by each of the image forming lenses composing the lens array is overlapped with an image formed by an adjacent image forming lens, and is inputted to the image sensor 5.

The signal processing section 25 includes an A/D converter 14 and an image synthesizer 15. The A/D converter 14 converts the electrical analog signal outputted from the image sensor 5 into a digital signal. The image synthesizer 15 performs synthetic processing which will be hereinbelow described to the image signal outputted from the A/D converter 14.

The object light, after transmitting through the liquid lens 2, enters into the lens array 3. The respective image forming lenses for composing the lens array 3 form the optical image of the object on the image sensor 5. At this time, unlike the case of Patent Document 1 in which a reduced image of the object is formed for every unit, the optical system according to this embodiment forms partial images of the object on the image sensors 5 of the respective unit, respectively. Meanwhile, since 25 units are formed, the imaging area of the object is divided into 25 areas, so that 25 partial images are formed. It should be noted that the respective partial images formed on the image sensor 5 are inverted images of the partial images according to an image forming function of the image forming lenses. The respective images formed on the image sensor 5, after being converted into the electrical analog signals by the CCD, are outputted to the signal processing section 25.

The partial images outputted from the respective units to the signal processing section 25, after being converted into the digital signal by the A/D converter 14, are subjected to the synthetic processing by the image synthesizer 15. The image synthesizer 15 rotates the respective partial images by 180 degrees about a center of the respective imaging areas, and converts from the inverted images into erect images. The image synthesizer 15 then synthesizes them to thereby output a synthetic image as one object image. In this case, since parts of imaging ranges of adjacent image forming lenses are partially overlapped, by utilizing an overlapped portion, respective partial images are connected using a pattern matching technique, such as well-known correlation processing. The connected synthetic image is recorded on a recording unit, or is displayed on a monitor.

According to this configuration, the compound-eye optical system forms the partial image of the object for every unit. Accordingly, a single object image which is the synthetic image of these can be obtained by the image synthesizer. In addition, since a diameter of the image forming lens is minute, a position of a principal point can be shifted compared with the case of using one image forming lens in the single optical system. As a result, a back focus can be reduced, thereby making it possible to reduce in size in the optical axis direction.

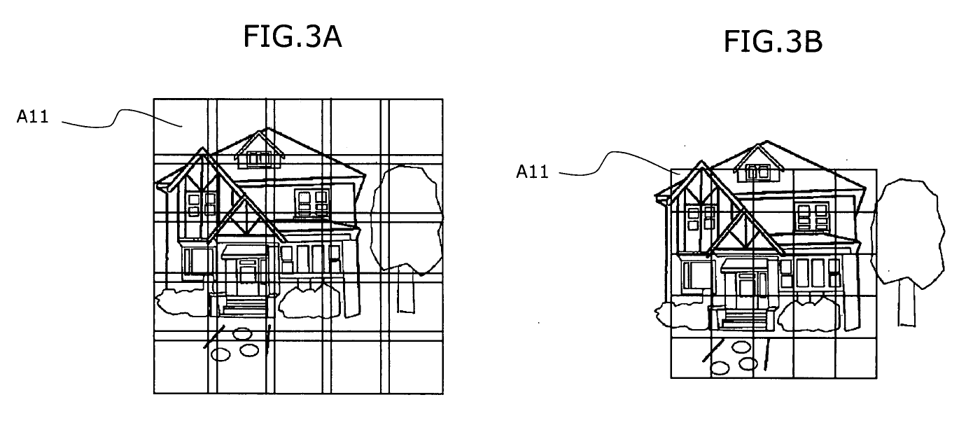

Next, a relationship between the focal length and an angle of view of the liquid lens 2 will be described using FIG. 3A and FIG. 3B. The area of the object whose image is taken is changed with the focal length of the liquid lens 2. As described above, the liquid lens 2 can adjust the area of the object whose image is taken by controlling the voltage applied by the driving voltage control section 16 to thereby changing the focal length thereof. In FIG. 3A and FIG. 3B, as for the partial image of the object included in the region All, the optical image is formed on the image sensor 5 by the unit All shown in FIG. 2.

When the voltage is applied to the liquid lens 2, since the focal length of the electrically insulating liquid 6 which has the lens function is reduced, as shown in FIG. 3A, it is possible to take a wide angle image in which the area of the object whose image is taken is wide. Meanwhile, when the voltage applied to the liquid lens 2 is reduced, since the focal length of the electrically insulating liquid 6 is increased, as shown in FIG. 3B, it is possible to take a telescopic image in which the area of the object whose image is taken is narrow. As a result, by applying the voltage to the liquid lens 2 according to a desired focal length, the area of the object whose image is taken can be varied, allowing a configuration with fewer mechanically movable parts.

According to the above configuration, the imaging apparatus according to the first embodiment can adjust the focal length by controlling the voltage applied to the liquid lens, allowing a zoom without increasing mechanically movable parts. Moreover, since the object light, after transmitting through the liquid lens, enters into the lens array and the optical image is thereby formed by respective image forming lenses, a distance between the image forming lens and the image sensor can be reduced. It is therefore possible to provide the imaging apparatus with high convenience, which is reduced in size in the optical axis direction and capable of zooming.

### Second Embodiment

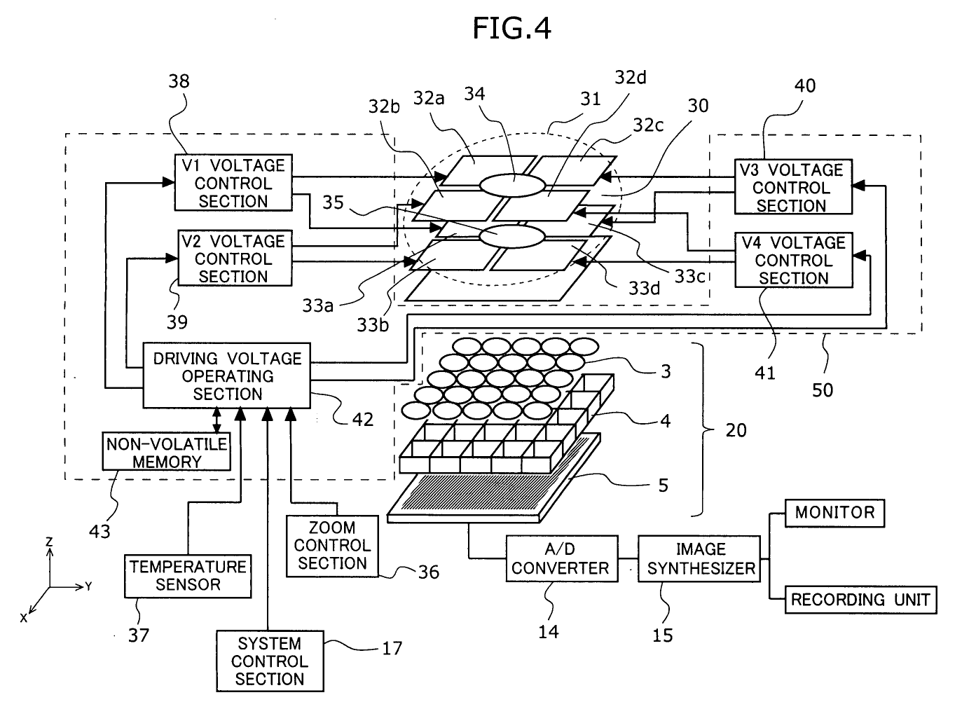

FIG. 4 is a schematic diagram and block diagram of a liquid crystal lens and a liquid crystal lens driving control section of an imaging apparatus according to a second embodiment of the present invention. The imaging apparatus according to the second embodiment is different from the imaging apparatus according to the first embodiment in that a liquid crystal lens is used for a deflection element as the focal length adjusting section instead of the liquid lens. Hereinafter, different points from the first embodiment will be described.

A liquid crystal lens 31 includes, in the order from a object side, an electrode 32 with a circular opening 34 in the center, an electrode 33 with a circular opening 35 in the center, and a liquid crystal layer 30 which is filled between the electrode 32 and the electrode 33. In FIG. 4, a light beam emitted from the object side is introduced to the circular opening 34, is transmitted through the liquid crystal layer 30, is then emitted from the circular opening 35, and reaches the image sensor 5.

The electrode 32 is composed of four electrodes, electrodes 32a, 32b, 32c, and 32d, which are obtained by equally dividing the electrode 32 into four, about the optical axis in a plane perpendicular to the optical axis direction. The electrode 33 is similarly composed of four electrodes 33a, 33b, 33c, and 33d, which are obtained by equally dividing the electrode 33 into four, about the optical axis in a plane perpendicularly to the optical axis direction. The electrode 32a and the electrode 33a, the electrode 32b and the electrode 33b, the electrode 32c and the electrode 33c, and the electrode 32d and the electrode 33d are arranged opposing to each other in the optical axis direction, respectively. Incidentally, transparent protection members which are not shown are arranged on a object side of the electrode 32, and an image side of the electrode 33 for sealing so that the liquid crystal layer 30 may not leak outside.

The liquid crystal layer 30 is composed of a well-known liquid crystal material, such as a nematic liquid crystal. It should be noted that the transparent protection members which are not shown, and the electrodes 32 and 33 are subjected to rubbing processing so that liquid crystal molecules of the liquid crystal layer 30 may be arranged in a direction perpendicular to the optical axis in the state where the voltage is not applied between the electrodes.

The liquid crystal lens driving control section 50 includes a V1 voltage control section 38, a V2 voltage control section 39, a V3 voltage control section 40, a V4 voltage control section 41, a driving voltage operating section 42, and a non-volatile memory 43. The V1 voltage control section 38 supplies a liquid crystal driving voltage V1 between the electrode 32a and the electrode 33a. Similarly, the V2 voltage control section 39 supplies a liquid crystal driving voltage V2 between the electrode 32b and the electrode 33b, the V3 voltage control section 40 supplies a liquid crystal driving voltage V3 between the electrode 32c and the electrode 33c, and the V4 voltage control section 41 supplies a liquid crystal driving voltage V4 between the electrode 32d and the electrode 33d, respectively.

The driving voltage operating section 42 receives a zoom control signal outputted from a zoom control section 36, and a signal regarding a temperature outputted from a temperature sensor 37, respectively. In addition, the driving voltage operating section 42 can call and receive data stored in the non-volatile memory 43. The driving voltage operating section 42 calculates the liquid crystal driving voltages V1 through V4 base on these signals and the data stored in the non-volatile memory 43. Subsequently, based on the operation result, the driving voltage operating section 42 outputs control signals corresponding to the liquid crystal driving voltages V1 through V4 to the V1 voltage control section 38, the V2 voltage control section 39, the V3 voltage control section 40, and the V4 voltage control section 41, respectively.

The non-volatile memory 43 stores, upon turning on a power, initial values of the liquid crystal driving voltages V1 through V4 to be supplied, and a temperature compensation table used for the case when an environmental temperature of the imaging apparatus changes in advance. In response to a request from the driving voltage operating section 42, the non-volatile memory 43 calls the stored data.

Next, a principle of the liquid crystal lens 31 will be described. As mentioned above, the liquid crystal lens 31 is equivalent to a plate which is optically uniform and has a constant refractive index when all of the liquid crystal driving voltages V1 through V4 are zero. As a result, the liquid crystal lens 31 does not serve as a lens element.

Under this state, when the liquid crystal driving voltages V1 through V4 are applied to respective electrodes, an arrangement direction of the liquid crystal molecules of the liquid crystal layer 30 will be changed. At this time, the liquid crystal molecules in an opposing portion between the electrode 32 and the electrode 33 are arranged in a z direction since the arrangement direction thereof is changed by the liquid crystal driving voltages. Meanwhile, the liquid crystal molecules near the center of the circular opening 34 and the circular opening 35 is not affected by the liquid crystal driving voltages, so that the arrangement direction thereof is not changed. When taken as a whole, when the liquid crystal driving voltages V1 through V4 are applied to the respective electrodes of the liquid crystal layer 30, as approaching to the center of the circular opening 34 and the circular opening 35 from the opposing portion between the electrode 32 and the electrode 33, the arrangement direction of the liquid crystal molecules are continuously changed from a state parallel to the z direction to a state perpendicular to the z direction.

The arrangement direction of the liquid crystal molecules corresponds to an alteration in the refractive index. In other words, a refractive index in a state where the liquid crystal molecules are parallel to the z direction is lower than that in a state where the liquid crystal molecules are perpendicular to the z direction. As a result, when the liquid crystal driving voltages V1 through V4 are applied to the respective electrodes of the liquid crystal layer 30, the liquid crystal lens 31 serves as a gradient index lens according to the arrangement direction of the liquid crystal molecules.

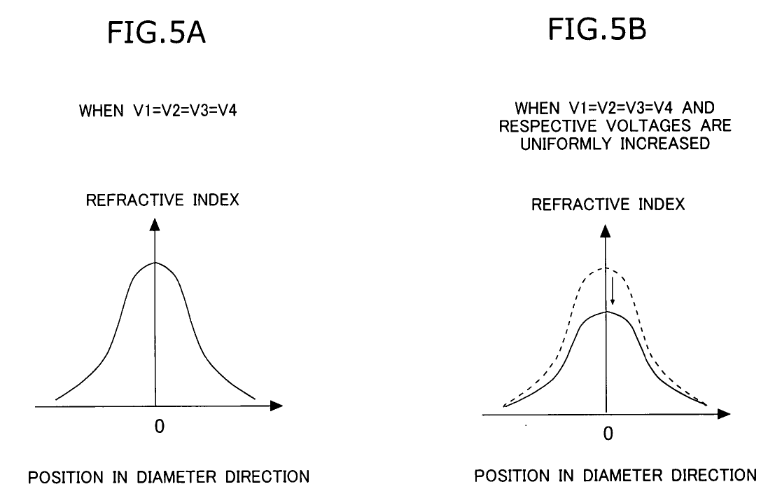

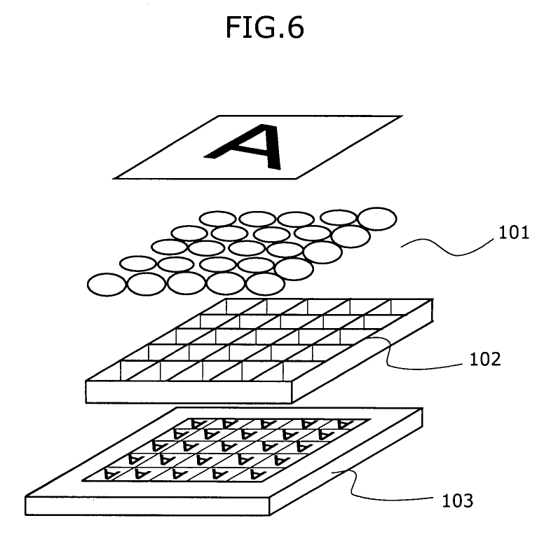

FIG. 5A and FIG. 5B are charts showing a relationship between the applied voltages to the liquid crystal lens of the imaging apparatus and a refractive index distribution in the direction perpendicular to the optical axis direction according to the second embodiment of the present invention. It should be noted that the both charts of FIG. 5A and FIG. 5B, in which the center of the circular opening 35 is an origin of coordinates in either cases, show the refractive index distributions in an yz plane including an origin point (namely, a plane including a boundary portion of the electrode 32a and the electrode 32b, a boundary portion of the electrode 32c and the electrode 32d, a boundary portion of the electrode 33a and the electrode 33b, and a boundary portion of the electrode 33c and the electrode 33d).

FIG. 5A is the chart showing the refractive index distribution in a diameter direction when the liquid crystal driving voltages satisfy V1=V2=V3=V4. As mentioned above, when the same liquid crystal driving voltages are applied to the respective electrodes, the liquid crystal lens 31 serves as the gradient index lens such that the refractive index of the center of the circular opening 34 and the circular opening 35 is higher, and the refractive index is reduced as departing from the center. At this time, the light beam entered into the liquid crystal lens 31 is introduced to the compound-eye optical system 20 due to the refractive index distribution of the liquid crystal layer 30 in a manner similar to that of transmitting through a normal lens element, and the optical image of the object is formed for every unit.

FIG. 5B is the chart showing the refractive index distribution in the diameter direction in the case where the applied voltages satisfy V1=V2=V3=V4, and the respective voltages are uniformly increased further than those shown in FIG. 5A. When values of the respective voltages are uniformly increased, the applied liquid crystal driving voltage comes to give a larger effect to the inside of the circular opening. For this reason, an absolute value of the refractive index in FIG. 5B becomes smaller than that in FIG. 5A. Since this state is equivalent to the variation of the focal length of the lens element, by associating the variation of the refractive index distribution with the focal length adjustment by zooming, zooming can be performed.

In the above configuration, upon turning on the power of the imaging apparatus, with the instruction from the system control section 17, the driving voltage operating section 42 of the liquid crystal lens driving control section 50 calls the initial value of the liquid crystal driving voltage stored in the non-volatile memory 43. In addition, the driving voltage operating section 42, with reference to the control signal on the environmental temperature outputted from the temperature sensor 37, calls a value of the corresponding environmental temperature from the temperature compensation table stored in the non-volatile memory 43. The driving voltage operating section 42 applies the liquid crystal driving voltages V1 through V4 that are specified from the called initial value and the temperature compensation table to the respective electrodes. By the applied respective liquid crystal driving voltages, the liquid crystal lens 31 serves as a lens element with a predetermined focal length, and the liquid crystal lens 31 and the compound-eye optical system 20 form the optical image of the object on the image sensor 5 of the respective units. At this time, in a manner similar to that of the first embodiment, due to the image forming function of the image forming lens, the inverted images of the partial images of the object are formed on the image sensors 5, respectively. The respective images formed on the image sensors 5, after being converted into the electrical analog signal by the CCD, are converted into the digital signal by the A/D converter 14. The partial images, after being converted into the digital signal by the A/D converter 14, are subjected to the synthetic processing by the image synthesizer 15.

When a focal length adjustment is directed with the instruction from the system control section 17, the zoom control section 36 will calculate a desired focal length. From the operation result, the zoom control section 36 generates the zoom control signal for adjusting the focal length of the liquid crystal lens 31, and outputs it to the driving voltage operating section 42. The driving voltage operating section 42 calculates the liquid crystal driving voltages V1 through V4 based on the zoom control signal and the temperature compensation table to thereby apply them to the respective electrodes. As a result, the focal length of the liquid crystal lens 31 varies, and the adjustment of the focal length is made.

According to the above configuration, in the imaging apparatus according to the second embodiment, since the liquid crystal lens can vary the focal length based on the inputted driving signal, it is possible to perform a zooming operation without increasing mechanically movable parts. Moreover, since the optical image is formed by the compound-eye optical system after the object light has transmitted through the liquid crystal lens, the distance between the image forming lens and the image sensor can be reduced, thereby making it possible to provide the imaging apparatus that is reduced in size.

In addition, the imaging apparatus according to the second embodiment is provided with the temperature sensor for detecting the environmental temperature of the imaging apparatus, so that the lens driving control section compensates the driving signal for driving the variable lens based on the environmental temperature that the temperature sensor has detected, allowing the degradation of an optical performance due to the change of the environmental temperature to be compensated.

Moreover, since the imaging apparatus according to the second embodiment is provided with the non-volatile memory, and the initial value of the refractive index distribution is stored in the non-volatile memory, while making it possible to promptly bring the imaging apparatus in use upon turning on the power, individual difference of the focal length and an image forming position of the imaging apparatus generated at the time of mass production can be compensated by the initial value. Furthermore, since the imaging apparatus according to the second embodiment is provided with the non-volatile memory and a correction value corresponding to the change in the environmental temperature is stored in the non-volatile memory, even when the environmental temperature changes, satisfactory optical performance can be achieved.

Incidentally, the focal length changing section is not limited to the deflection element shown in the first and the second embodiments, but may arrange a lens system and a reflective mirror on the object side of the compound-eye optical system.

In addition, the lens system may be a single or a plurality of lens units. In this case, by adjusting a relative distance between the lens units, or the lens units and the reflective mirror, the focal length can be adjusted.

In addition, the respective lens units may arrange a single or a plurality of lens elements. Meanwhile, at least one of the lens elements among the respective lens units may be a diffraction lens. By using the diffraction lens, it is possible to reduce in size in the optical axis direction.

Incidentally, in the imaging apparatus according to the first and the second embodiments, while the object image formed by the respective image forming lenses has been the partial images of the object, it is not limited to this. The reduced images of object whose number is equal to that of the respective image forming lenses may be formed on the image sensor. By synthesizing these reduced images, a single object image can be obtained.

Incidentally, in the imaging apparatus according to the first and the second embodiments, while the image forming lens for composing the lens array has been the total of 25 lenses in number, five lenses in the X direction, and five lenses in the Y direction, respectively, in the single plane, it is not limited to this. The image forming lenses may not be arranged in square arrays, but for example, a total of 20 lenses may be arranged, five lenses in the X direction, and four lenses in the Y direction.

Incidentally, the two-dimensional arrangement of the unit is not limited on the single plane shown in the first and the second embodiments, but may be on a curved surface, such as a virtual spherical surface.

While the present invention has been shown and described in detail, the foregoing description is in all aspects illustrative and not restrictive. It is therefore understood that numerous other modifications and variations can be devised without departing from the scope of the invention.

What is claimed is:

1. An imaging apparatus comprising:
an imaging optical system for forming an optical image of an object, the imaging optical system including a focal length adjusting section adjustable a focal length based on an input signal and a plurality of image forming lenses for receiving a light that has transmitted through said focal length adjusting section to form the optical image of the object; and
an image sensor for generating an electrical image signal obtained by converting the optical image,
wherein a unit is composed of each of the image forming lens and an image taking area on the image sensor having a plurality of light receiving sections for receiving the optical image, and a plurality of units being two-dimensionally arranged.

2. The imaging apparatus according to claim 1, wherein said focal length adjusting section includes a deflection element for adjusting a focal length.

3. The imaging apparatus according to claim 2, wherein said deflection element is a lens including a liquid capable of focusing a light beam transmitted therethrough, and by changing a shape of the liquid based on a control signal inputted from an external source, the focal length is changed.

4. The imaging apparatus according to claim 2, wherein said deflection element is a refractive index distribution lens including a liquid crystal for focusing a light beam transmitted therethrough, and by changing the refractive index distribution of the refractive index distribution lens based on a control signal inputted from an external source, a focal length is adjusted.

5. The imaging apparatus according to claim 1, further comprising an image synthesizer for generating an image signal of a object image based on a plurality of the image signals outputted from a plurality of the units.
